(19) United States
(12) Patent Application Publication
(10) Pub. No.: US 2015/0159844 A1
(43) Pub. Date: Jun. 11, 2015

(54) DECORATIVE LIGHTING SYSTEM AND RELATED COMPONENTS

(71) Applicant: Gemmy Industries Corporation, Coppell, TX (US)

(72) Inventors: Daniel G. FLAHERTY, Irving, TX (US); Chengchun Zhang, Shenzhen City (CN)

(21) Appl. No.: 14/567,215

(22) Filed: Dec. 11, 2014

Related U.S. Application Data
(60) Provisional application No. 61/914,699, filed on Dec. 11, 2013.

(51) Int. Cl. F21V 23/00; F21V 23/06; F21V 29/00

(52) U.S. Cl. CPC F21V 23/001; F21V 23/008; F21V 29/22; F21V 23/06; F21W 2121/00

(57) ABSTRACT

A lighting system can include: a plurality of light modules electrically coupled to a first cable, the first cable having a first electric coupler. Each light module can include: a housing including one or more brackets adapted to attach to an existing structure; and a light emitting diode (LED) light source contained within the housing, the LED light source electrically connected to the first cable. The lighting system can further include: a controller adapted to couple to an AC power receptacle to receive AC power, the controller including an electrical output having a second electric coupler adapted to physically and electrically connect to the first electric coupler. The controller can be adapted to illuminate the LED light sources of the plurality of light modules according to a plurality of pre-set programs, and the controller can include a user-operable selector adapted to select one of the pre-set programs.

### CROSS-REFERENCE TO RELATED APPLICATION

This application claims priority under 35 U.S.C. Section 119 to U.S. Provisional Application No. 61/914,699, filed Dec. 11, 2013, the entire content of which is incorporated herein by reference.

### TECHNICAL FIELD

This patent application relates generally to lighting systems and components. More specifically, this patent application relates to decorative lighting systems and components, for example, for use in or around a building, such as a house, or surrounding structures.

### BACKGROUND

Lighting systems are commonly used for decorative or environmental purposes. For example, during the holidays, people often place electric lights on their houses or landscaping surrounding their houses. These lights typically consist of one or more lengths of conductive wire, each length of wire having multiple lights (e.g., light bulbs) distributed there along. The lengths of wire and/or lights can be secured to the house, landscaping, or other object in various ways, such as by wrapping the wire around the object, using clips attached to the lights, or using fasteners such as nails or tacks.

### SUMMARY

According to an embodiment, a lighting system can comprise: a plurality of light modules electrically coupled to a first cable, the first cable having a first electric coupler, each light module comprising: a housing including one or more brackets adapted to attach to an existing structure; and a light emitting diode (LED) light source contained within the housing, the LED light source electrically connected to the first cable; and a controller adapted to couple to an AC power receptacle to receive AC power, the controller including an electrical output having a second electric coupler adapted to physically and electrically connect to the first electric coupler; wherein the controller is adapted to illuminate the LED light sources of the plurality of light modules according to a plurality of pre-set programs, and the controller includes a user-operable selector adapted to select one of the pre-set programs.

According to another embodiment, a component for a lighting system can comprise: a cable including a first end with a first threaded electric coupler and a second end with second threaded electric coupler; and a plurality of light modules distributed along the cable, each light module comprising: a housing including one or more brackets adapted to attach to an existing structure; a multi-color light emitting diode (LED) light source contained within the housing; and a heat sink located in the housing.

### BRIEF DESCRIPTION OF THE DRAWINGS

The foregoing aspects and other features and advantages of the invention will be apparent from the following drawings, wherein like reference numbers generally indicate identical, functionally similar, and/or structurally similar elements.

FIG. 1 is a perspective view of an embodiment of a lighting system mounted underneath the eave of a house.

FIG. 2 is a side view of an embodiment of a light module of FIG. 1, mounted underneath the eave of a house.

FIG. 3 is an enlarged, side view of the light module of FIG. 2.

FIG. 4 is a perspective view of an embodiment of components of the lighting system of FIG. 1.

FIG. 5 is a side view of an embodiment of a lighting system mounted to a tree.

FIG. 6 is a perspective view of an embodiment of components of the lighting system of FIG. 5.

FIGS. 7A, 7B, 7C, 7D, and 7E depict a front-perspective, top, side, rear-perspective, and front view, respectively, of an embodiment of a light module.

FIGS. 8A, 8B, and 8C depict a front-perspective, rear-perspective, and exploded view, respectively, of another embodiment of a light module.

FIGS. 9A, 9B, and 9C depict a front-perspective, rear-perspective, and exploded view, respectively, of another embodiment of a light module.

FIG. 10 depicts another embodiment of a lighting system according to the present invention.

FIGS. 11A and 11B depict a front-perspective and a side view, respectively, of the control unit of FIG. 10.

FIGS. 12A, 12B, 12C, and 12D depict a front-perspective, top, side, and exploded view, respectively, of another embodiment of a light module.

FIG. 13 depicts another embodiment of a lighting system according to the present invention.

FIGS. 14A, 14B, 14C, and 14D depict a front-perspective, top, side, and exploded view, respectively, of another embodiment of a light module.

FIG. 15 depicts an electrical diagram of an embodiment of a lighting system according to the present invention.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without departing from the spirit and scope of the invention. All references cited herein are incorporated by reference as if each had been individually incorporated.

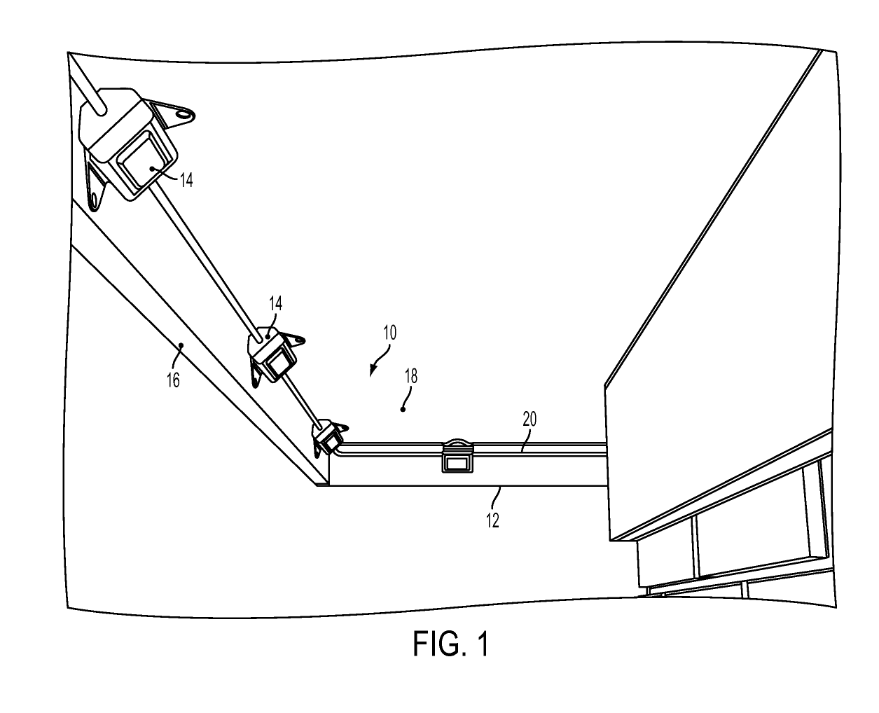

Referring to FIG. 1, an embodiment of a lighting system 10 is shown. Lighting system 10 can be used to provide decorative or environmental lighting in a variety of interior or exterior applications. For example, the lighting system 10 can be mounted under the eave 12 of a house, as shown in FIG. 1. Alternatively, the lighting system 10 can be mounted to another part of a house, such as along edges of the roof, or along the top of a fence. Other applications can include mounting the lighting system to trees or other landscaping. Interior applications are also possible, such as on or around a ceiling or walls. Still further, the lighting system 10 can be used without limitation on commercial and industrial buildings, or on stadiums.

FIG. 1 depicts an embodiment where a plurality of light modules 14 are mounted under the eave 12, e.g., in a corner space formed between a fascia 16 and a soffit 18, however, other mounting locations are possible. As shown in FIG. 1, each light module 14 can include a housing having one or more mounting brackets (described in more detail below), that allow the module 14 to be securely mounted under the eave, for example, using nails, screws, adhesives, or other fasteners known in the art. The housing and mounting brackets can facilitate mounting the light modules 14 under the eave, or on some other structure, for extended periods of time.

Still referring to FIG. 1, electrical cable 20 can extend between adjacent pairs of the light modules 14. According to embodiments, the light modules 14 can be spaced equidistantly from one another along cable 20, or alternatively, the light modules 14 can be spaced in uneven intervals. According to other embodiments, the location of each light module 14 on cable 20 can be adjusted. As will be discussed below, a plurality of cables can be linked in series (e.g., end-to-end via waterproof connectors) or in parallel (e.g., connecting to a distributor via waterproof connectors) to fit a desired installation and/or visual effect.

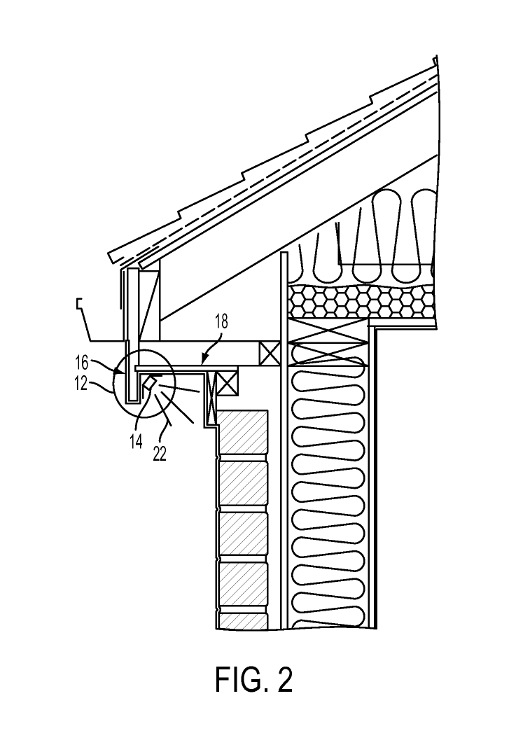

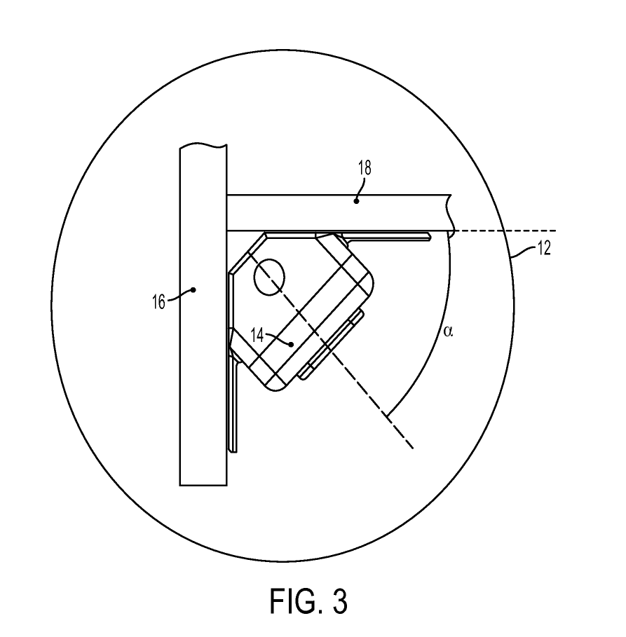

FIGS. 2 and 3 depict a side view of one of the light modules 14 mounted under an eave 12. According to embodiments, the light module 14 can be fastened to the fascia 16 alone, the soffit 18 alone, or to both. In the embodiment shown, the module 14 mounts at an angle α (see FIG. 3) with respect to the soffit 18 of about 45°. This may be done, for example, to maximize the cone of light 22 emitted by the module 14 (see FIG. 2), however other angles are possible, such as an angle α between about 30° and about 60°.

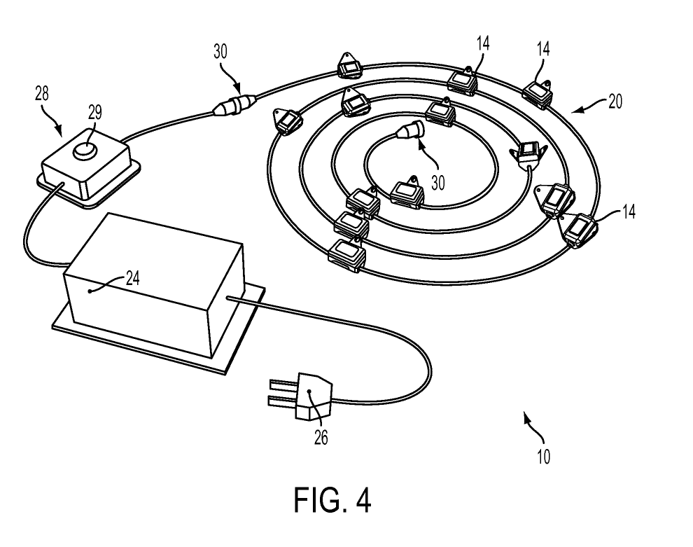

FIG. 4 depicts an embodiment of lighting system 10 detached from a building or other object. The system 10 can include one or more of the cables 20 and a plurality of light modules 14, as described above. The system can also include a power supply 24 that receives electrical power, for example, from an AC plug 26 or other connector adapted to plug into an electrical outlet, such as an 110V, 120V, 220V, or 240V AC outlet. The system can also include a controller 28 connected between the power supply 24 and the light modules 14. According to an alternative embodiment, the power supply 24 and the controller 28 can be integrated into a single unit. Mating cord couplers 30 are provided to facilitate disconnecting and reconnecting the cable 20 to the controller 28, and/or to facilitate connection of multiple cables 20 in an end-to-end arrangement, for example, to extend the length of the light string. According to embodiments, the cord couplers 30 can be weather resistant, e.g., they can form a water tight seal around the underlying electrical components. This can be accomplished, for example, by using couplers 30 having plastic or rubber material with mating threaded portions, or by using threaded metal couplers having a rubber gasket, O-ring, or the like. One of ordinary skill in the art will appreciate from this disclosure that other structures can be used to from a weatherproof connection between adjoined couplers 30, including those without threads.

According to embodiments, the controller houses a circuit, such as a printed circuit board (PCB), that is programmed to provide a variety of user-selectable light shows, such as seasonal and/or year-round light shows. For example, according to embodiments, the user can press button 29 to scroll through a menu and select the light pattern they desire. Different lighting patterns can range from steady burn to light changing, color changing, blinking lights, chasing lights, and other patterns and sequences as may be desired by the user.

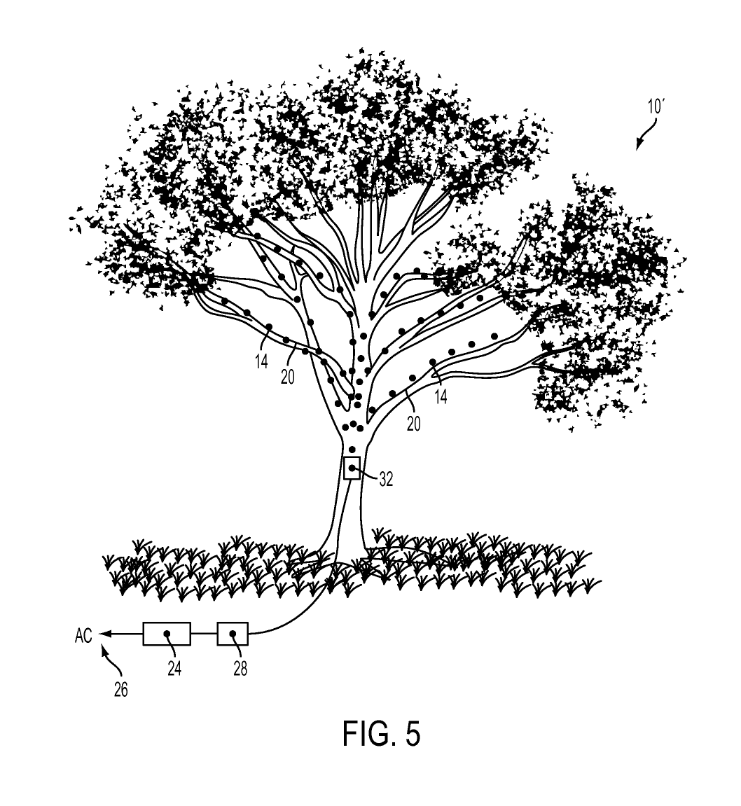

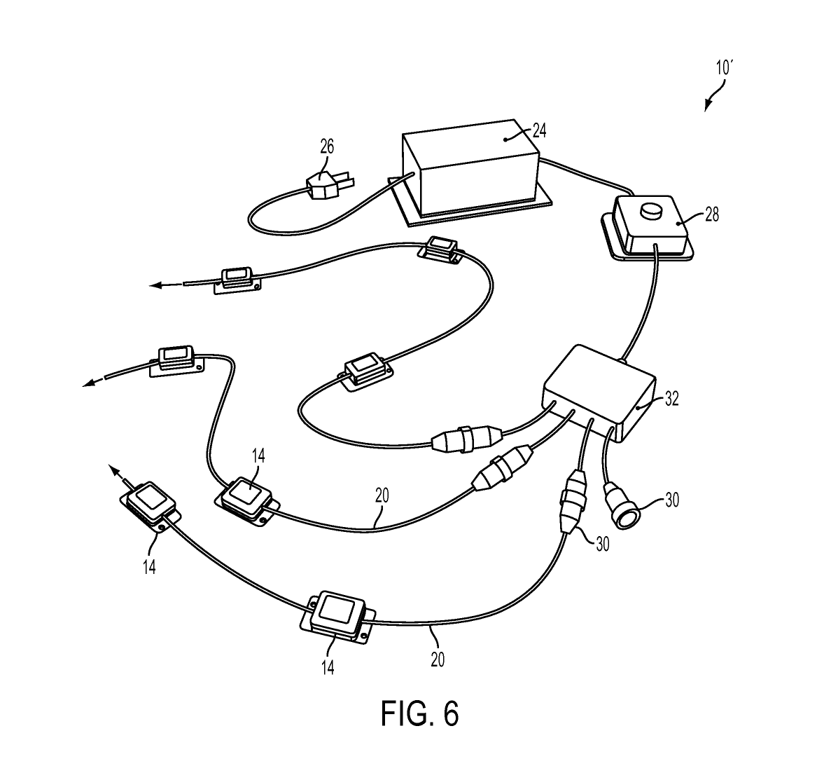

FIGS. 5 and 6 depict another embodiment of a lighting system that can be mounted on a tree or other freestanding object. Lighting system 10′ is substantially similar to the system described and shown with respect to FIGS. 1-4, above, except for the differences indicated below. As shown in FIGS. 5 and 6, lighting system 10′ can include a distributor 32 that allows multiple cables 20 to branch off from the controller 28, for example, in parallel. Although distributor 32 is shown as a stand-alone unit in FIGS. 5 and 6, alternative embodiments can have the distributor 32 integrated with the controller 28 and/or the power supply 24. The distributor 32 can also be connected to the controller 28 and/or power supply 24 by removable connection, such as by weatherproof couplers 30 described above.

The distributor 32 can also include a plurality of cord couplers 30 to allow a user to connect a desired amount of cables 20 to the distributor 32 to fit their desired application. Additionally, multiple distributors can be included to allow branching of the cables 20 at a variety of locations. As shown in FIG. 6, the embodiment of light modules 14 shown can include a substantially flat mounting bracket with one or more holes to facilitate surface mounting to a tree or other structure, for example, using a nail, screw, or other fastener. According to embodiments, the power supply 24 and/or the controller 28 can output AC power to the modules 14. For example, the controller 28 and/or power supply 24 can step down the voltage from 120V to 12V or 24V, although other variations are possible. Alternatively, the controller 28 and/or power supply 24 can output DC power to the modules 14. According to DC embodiments, the controller 28 and/or power supply 24 can similarly step down the voltage output to the modules 14.

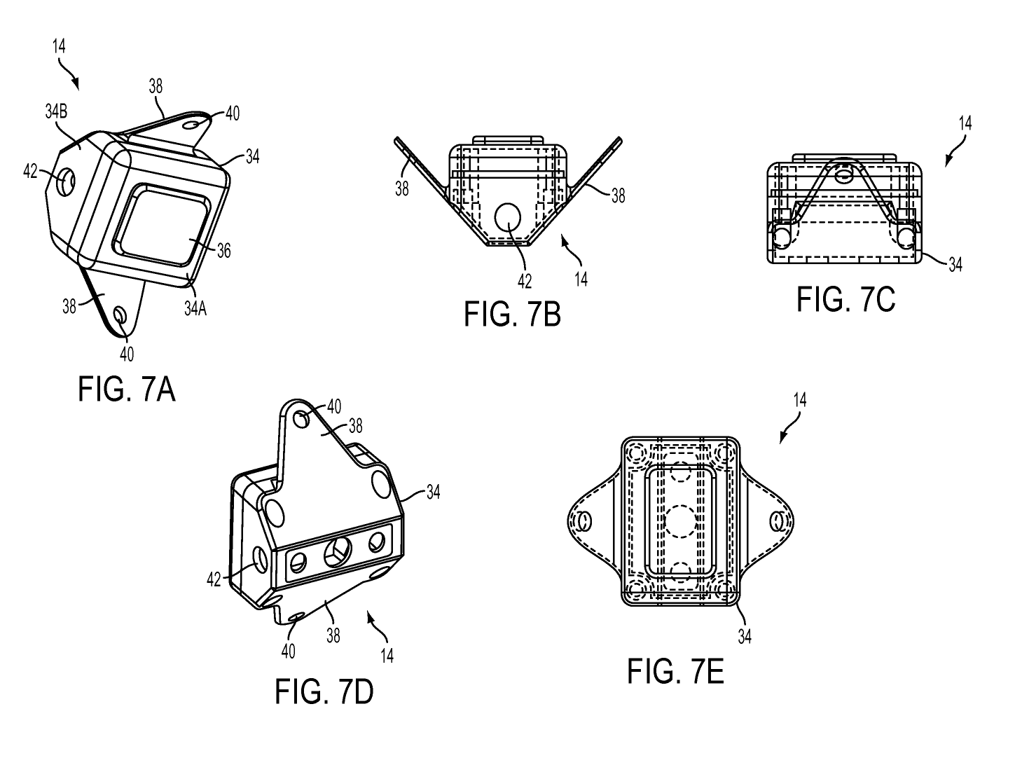

FIGS. 7A-E depict an embodiment of a light module 14 from a variety of vantage points. As shown, light module 14 can include a housing 34 that forms the external structure of the light module 14. Housing 34 can contain a light source, such as one or more LEDs (e.g., multicolor or RGB LEDs), halogen light bulbs, fluorescent light bulbs, etc., as well as associated electronics and/or electrical connections. According to an embodiment, housing 34 can be substantially watertight to protect the elements located inside of it. According to embodiments, housing 34 can be formed of plastic, metal, or combinations thereof.

Still referring to FIGS. 7A-E, housing 34 can include one or more windows 36 formed, for example, of transparent or translucent material, to permit light to pass from the light source inside the housing. According to embodiments, the window 36 can be clear or colored. The housing 34 can also include one or more brackets 38 adapted to mount the housing 34 onto another structure. For example, in the embodiment shown, brackets 38 include apertures 40 that permit screws, nails, or other fasteners to pass through the brackets 38 and secure the housing in place on a structure. One of ordinary skill in the art will recognize from this disclosure that other types of fastener arrangements can be used instead of the apertures 40 and screws or nails.

The housing 34 also includes openings 42 at each end to receive the cable 20, preferably in a watertight fashion.

For example, a threaded compression gasket can secure the cable 20 in each opening 42. Alternatively, silicone glue, caulk, or other type of sealant can provide a waterproof seal between the cable and openings 42.

Referring to FIG. 7A, according to an embodiment, the housing 34 can comprise upper and lower housing portions 34A, 34B joined together, for example, using screws, and the brackets 38 can comprise a metal component secured to the lower housing 38B, for example, using screws. The upper and lower housing portions 34A, 34B can be formed of transparent or translucent plastic, however, other configurations are possible.

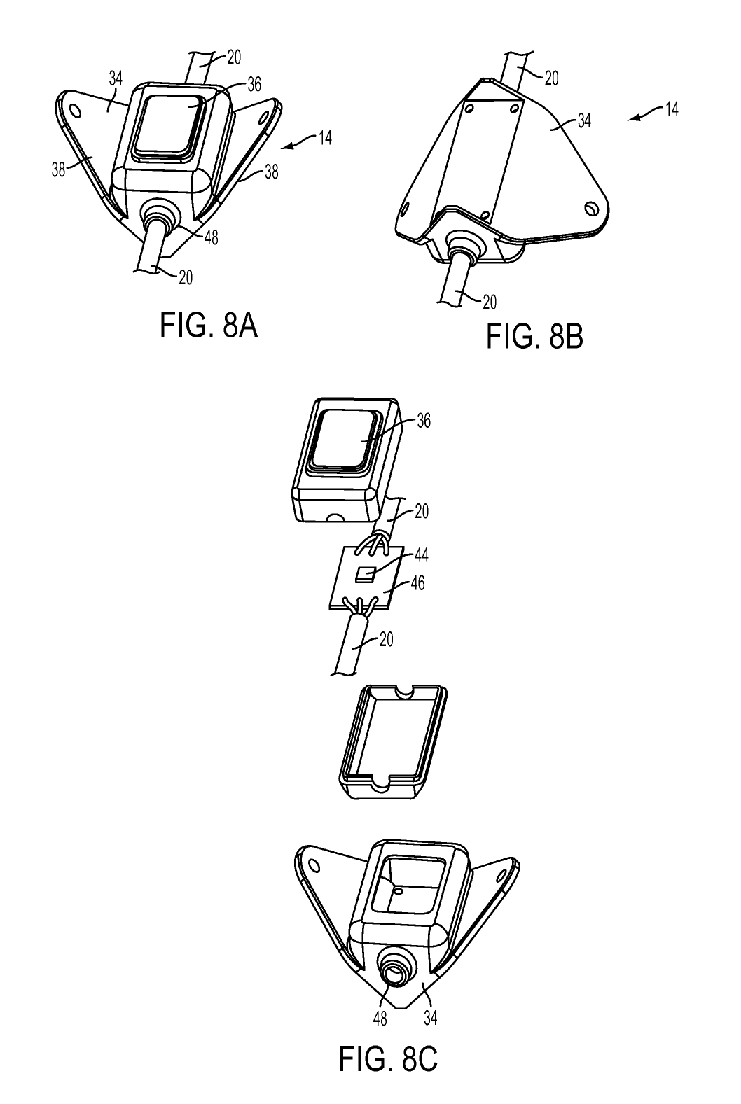

FIGS. 8A-C depict another embodiment of a light module 14 from a variety of vantage points, including an exploded view. As shown, module 14 can contain a light source, such as an LED 44. The LED 44 can be a multi-color LED, such as a RGB LED. The LED 44 can be electrically connected to cable 20 via a printed circuit board (PCB) 46, however, other configurations are possible. The window 36 can comprise part of a clamshell member that surrounds the LED 44 and PCB 46, for example, in a watertight fashion. Gaskets 48 can be located in openings 42 to form a watertight seal around cable 20, however, other types of seals can alternatively be used.

According to embodiments, the window 36 can be transparent or translucent (e.g., colored), and the surrounding portions can be opaque, however, in other embodiments, the entire housing 34 can be transparent or translucent. In the embodiment of FIGS. 8A-C, the brackets 38 are formed integrally with surrounding portions of the housing, however, as discussed above in other embodiments, the brackets can alternatively be separate parts (e.g., metal) fastened to the remainder of housing 34.

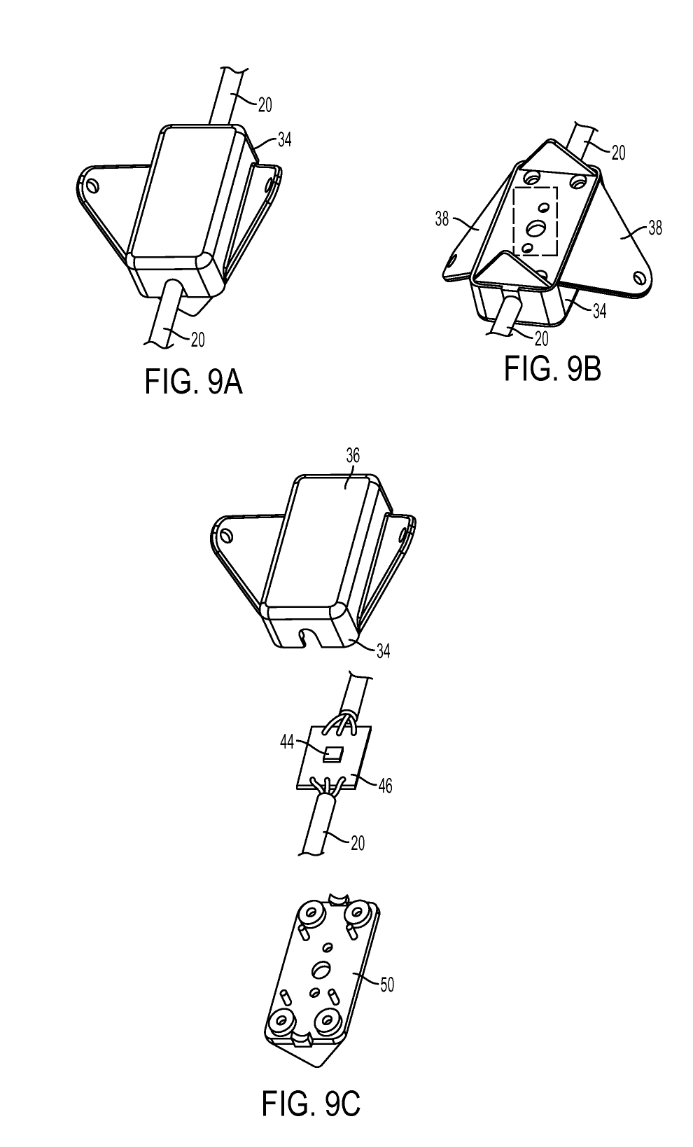

FIGS. 9A-C depict another embodiment where the window 36 is part of the housing 34 itself. For example, all or a portion of housing 34 could be made of a transparent or translucent material, some of which could optionally be covered with an opaque paint or other coating to reduce the size of the window. Alternatively, the housing 34 could be co-molded or otherwise constructed of two or more materials, at least one of which is translucent or transparent. One of ordinary skill in the art will appreciate from this disclosure that a variety of different techniques can be utilized to form one or more transparent or translucent windows in the housing 34, either integrally or separately and attached thereto. FIGS. 9A-C also depict a cover 50 that covers a rear portion of the housing 34. According to embodiments, the window 36 can be colored, such as translucent red, translucent blue, or translucent yellow, etc. In the embodiment of FIGS. 9A-C, the brackets 38 are formed integrally with a top portion of the housing 34, however, according to alternative embodiments, the brackets 38 can be separate parts (e.g., metal) that are fastened to the remainder of the housing 34.

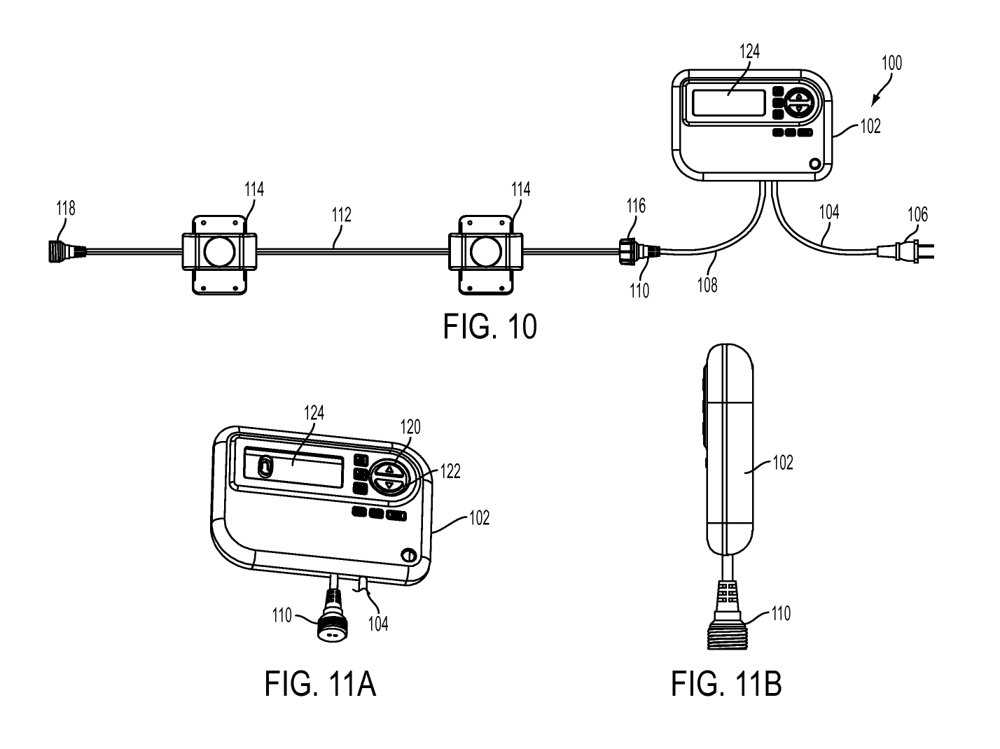

FIGS. 10-14 depict additional embodiments of the lighting system. The features of FIGS. 10-14 can be intermixed with the features of FIGS. 1-9, and vice versa, except where they are technically incompatible.

Referring to FIG. 10, according to embodiments, the lighting system 100 can include a plurality of light modules 114 electrically coupled to a first cable 112, the first cable having a first electric coupler 116. The lighting system 100 can also include a controller 102 adapted to couple to an AC power receptacle to receive AC power (e.g., 110V, 120V, 220V, 240V AC power), for example, through cable 104 and plug 106, however, other embodiments are possible. The controller 102 can include an electrical output 108 having a second electric coupler 110 adapted to physically and electrically connect to the first electric coupler 110. The first and second electric couplers 116, 110 can form a watertight seal, and can have a similar arrangement as described previously for coupler 30.

The controller 102 can be adapted to illuminate light sources of the plurality of light modules 114 (e.g., LED light sources such as RGB LEDs) according to a plurality of pre-set programs. Example programs can include “starry night,” “glimmer,” “sparkle,” “steady burn,” and various light show themes, and combinations thereof. Pre-set programs can also include different color themes, such as pure white, soft white, gold, red, yellow, green, blue, lavender, pink, chasing colors (red-white-blue), and various combinations thereof.

The controller 102 can include a user-operable selector, such as buttons 120, 122 to select one or more of the pre-set programs. For example, the user can scroll through a list of the programs shown on display 124, and select the desired program using buttons 120, 122. Alternatively, the selector can be operated remotely, for example, through a Bluetooth connection, infrared remote control, or other remote signal.

Although not shown in FIG. 10, the lighting system 100 can include additional sets of light modules 114 located on additional cables 112. For example, a second plurality of light modules can be electrically coupled to a second cable. The first cable 112 can have a third electric coupler 118, e.g., located opposite to coupler 116, and the second cable can include a fourth electric coupler (not shown) adapted to physically and electrically connect to the third electric coupler 118, e.g., in a similar manner discussed above with coupler 30. In this manner, multiple sets of cables 112 and light modules 114 can be connected end-to-end to achieve a desired length.

FIGS. 11A and 11B are perspective and side views, respectively, of the controller 102. Referring to FIGS. 10, 11A, and 11B, the controller 102 can include an integrated power supply (not shown) that is located in the housing of controller 102. For example, the power supply can receive the AC input from cable 104, and convert the AC power for downstream use by the controller 102 and/or light modules 114. Alternatively, the power supply can be separate from the controller 102, for example, as shown in the embodiments of FIGS. 4 and 6.

According to embodiments, the controller 102 can output AC power to the light modules 114 through the electrical output 108. For example, the controller 102 (or power supply) can step down the AC power to 12V or 24V for transmission to the light modules, however, other values are possible. Alternatively, the controller 102 can output DC power to the light modules 114 through the electrical output 108. According to DC embodiments, the controller (or power supply) can step down the DC power to 12V, 24V, or other voltage suitable for use by the light modules 114.

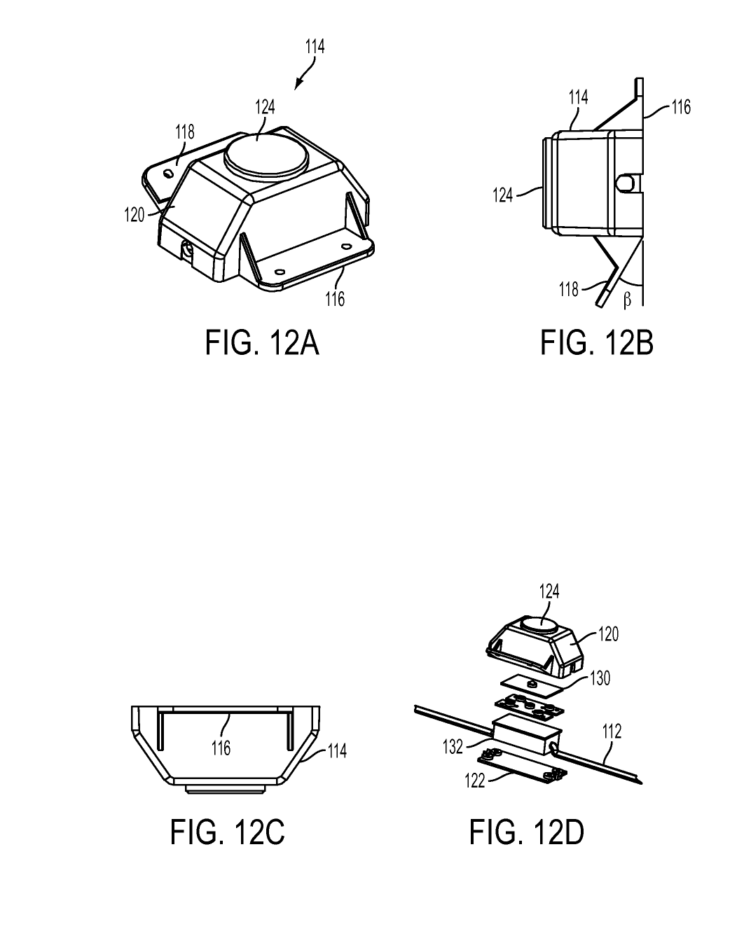

FIGS. 12A-D depict an embodiment of one of the light modules 114. Light modules 114 can be substantially similar to the embodiments described in FIGS. 1-9. Accordingly, only noteworthy differences will be described below. As shown in FIGS. 12A and 12B, light module 114 can include first and second mounting brackets 116, 118 that are inclined at different angles. For example, first mounting bracket 116 can be substantially co-extensive with the rear of the light module housing, making the mounting bracket 116 suitable for flush mounting the light module 114 to a surface. Second bracket 118 can be inclined with respect to the rear of the light module housing, for example, by an angle β of between about 15° and about 45°, for example, about 30°. The second bracket 118 can be used as an alternative to the first bracket 118 to mount the light module 114 at an incline to a surface.

Referring to the exploded view of FIG. 12D, the light module 114 can include a weather resistant clamshell housing 120, 122 that can be completely transparent or translucent, or can be opaque with a transparent or translucent window 124, as has been described in previous embodiments. The housing 120, 122 can include the brackets 116, 118. The housing 120, 122 can also house a circuit board 130 (such as a printed circuit board) supporting one or more LEDs (e.g., multi-color RGB LEDs) in electrical connection with the cable 112. The housing 120, 122 can also contain a heat sink 132 in thermal communication with the circuit board 130, such that the heat sink draws heat away from the circuit board 130 and LEDs, to maintain an acceptable temperature for the LEDs. According to embodiments, the heat sink 132 can be formed of metal, such as aluminum alloys, copper, composites, or combinations thereof. The heat sink 132 can also include fins (not shown) or other features configured to further draw heat away from the circuit board 130.

As discussed above, the controller 102 can send electrical power and/or a signal to the light modules 114 in a manner that causes the various LEDs in a light string or sets of connected light strings to illuminate in desired patterns, colors, and combinations thereof.

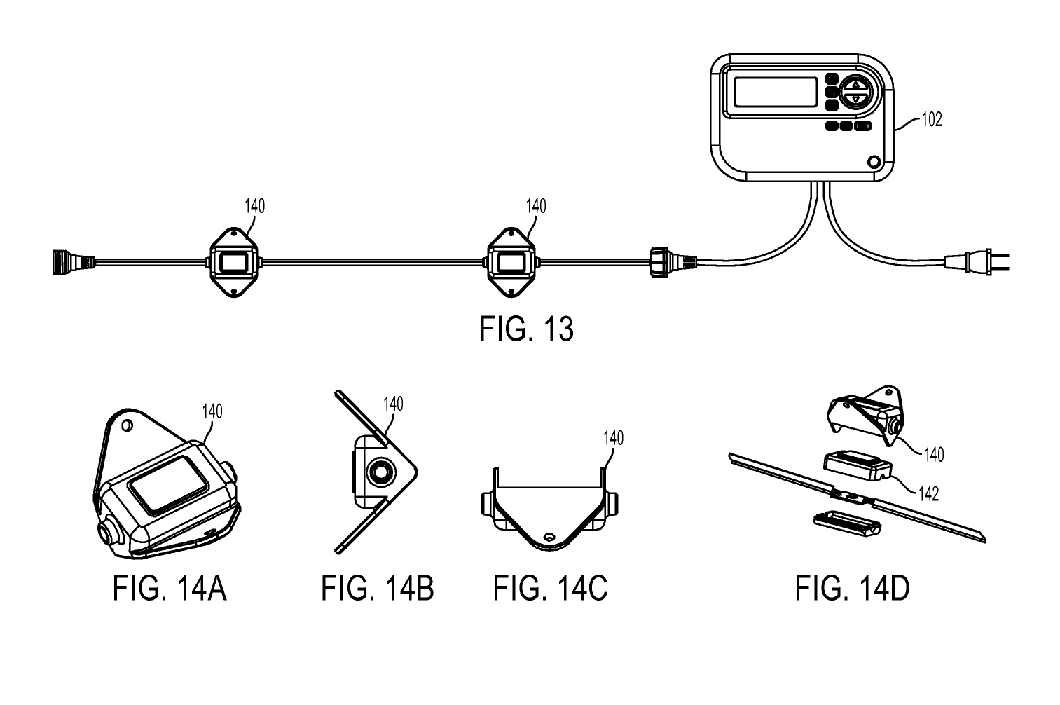

FIG. 13 depicts an embodiment where controller 102 is used with a plurality of light modules 140 that are substantially the same as light modules 14 of FIGS. 8A-C, except that light modules 140 further include a heat sink 142 similar to heat sink 132 described above.

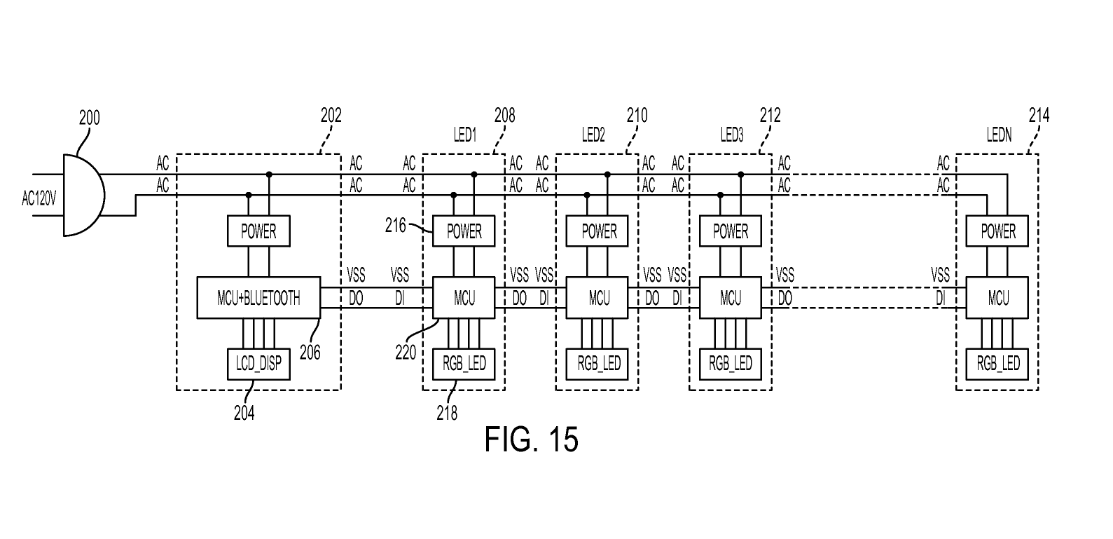

FIG. 15 depicts an electrical diagram of an embodiment of a lighting system according to the present invention. FIG. 15 depicts a plug 200 adapted to connect to an AC power receptacle, for example, to plug into a 120V AC receptacle. The plug transmits the AC power to the controller 202, which converts the AC power (e.g., steps it down to 12V or 24V, and/or converts it to DC power) for use by the microcontroller (MCU), LCD display, and Bluetooth or other remote connection 206. According to the embodiment shown, the controller 202 then outputs the power (e.g. AC power) to a plurality of series-connected light modules 208, 210, 212, 214, for example, located on one or more light strings. Each of the light modules can in turn include a power module 216 that receives AC power from the controller 202, an LED 218, and a MCU 220 that receives the AC power and the signals from the controller 202, and uses those signals to illuminate the LEDs 218 in the desired color and for the desired duration. One of ordinary skill in the art will appreciate from this disclosure that other circuit configurations can be used to illuminate the LEDs in the desired colors and patterns.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A lighting system, comprising:
a plurality of light modules electrically coupled to a first cable, the first cable having a first electric coupler, each light module comprising:
a housing including one or more brackets adapted to attach to an existing structure; and
a light emitting diode (LED) light source contained within the housing, the LED light source electrically connected to the first cable; and
a controller adapted to couple to an AC power receptacle to receive AC power, the controller including an electrical output having a second electric coupler adapted to physically and electrically connect to the first electric coupler;
wherein the controller is adapted to illuminate the LED light sources of the plurality of light modules according to a plurality of pre-set programs, and the controller includes a user-operable selector adapted to select one of the pre-set programs.

2. The lighting system of claim 1, wherein the controller includes a plug adapted to connect to an AC power receptacle.

3. The lighting system of claim 1, wherein the controller couples to the AC power receptacle by an intervening power supply having a plug adapted to connect to an AC power receptacle.

4. The lighting system of claim 3, wherein the controller and the power supply are integrated into a single housing.

5. The lighting system of claim 3, wherein the controller and the power supply are located in separate housings.

6. The lighting system of claim 1, further comprising a second plurality of light modules electrically coupled to a second cable, wherein the first cable includes a third electric coupler and the second cable includes a fourth electric coupler adapted to physically and electrically connect to the third electric coupler.

7. The lighting system of claim 1, wherein the controller is adapted to couple to a 120V or 240V AC power receptacle.

8. The lighting system of claim 1, wherein the controller is adapted to output AC power through the electrical output.

9. The lighting system of claim 8, wherein the controller is adapted to reduce the voltage of the AC power before it is output through the electrical output.

10. The lighting system of claim 1, wherein the controller is adapted to output DC power through the electrical output.

11. The lighting system of claim 1, wherein the controller further includes a display screen adapted to output the pre-set program currently selected by the user.

12. The lighting system of claim 1, wherein the controller is adapted to control the LED light sources of the light modules to output light of different colors.

13. The lighting system of claim 12, wherein the LED light sources comprise multi-color LEDs.

14. The lighting system of claim 13, wherein the LED light sources comprise RGB LEDs.

15. The lighting system of claim 1, wherein the selector on the control unit comprises a button.

16. The lighting system of claim 1, wherein the selector on the control unit is adapted to receive a remote signal.

17. The lighting system of claim 1, wherein each module further comprises a heat sink located in the housing.

18. The lighting system of claim 1, wherein the first electric coupler and the second electric coupler together form a weatherproof connection.

19. The lighting system of claim 1, further comprising a distributor electrically coupled to the controller, the distributor adapted to electrically couple the first cable and a second cable containing a second plurality of light modules in parallel.

20. A component for a lighting system, comprising:
a cable including a first end with a first threaded electric coupler and a second end with second threaded electric coupler; and
a plurality of light modules distributed along the cable, each light module comprising:
a housing including one or more brackets adapted to attach to an existing structure;
a multi-color light emitting diode (LED) light source contained within the housing; and
a heat sink located in the housing.
